(19) United States
(12) Patent Application Publication
(10) Pub. No.: US 2016/0068270 A1
(43) Pub. Date: Mar. 10, 2016

(54) AIR GENERATION UNIT FOR AN AIRCRAFT

(71) Applicant: Airbus Defence and Space GmbH, Ottobrunn (DE)

(72) Inventor: Michael Meyer, Munich (DE)

(73) Assignee: Airbus Defence and Space GmbH, Ottobrunn (DE)

(21) Appl. No.: 14/847,129

(22) Filed: Sep. 8, 2015

(30) Foreign Application Priority Data
Sep. 9, 2014 (EP) 14 184 073.6

(51) Int. Cl. B64D 13/06

(52) U.S. Cl. CPC B64D 13/06

(57) ABSTRACT

An air generation unit for an aircraft, an air generation arrangement, an aircraft and a method for operating an air generation unit in an aircraft are described. The air generation unit for an aircraft includes an air supply means and a control unit. The air supply means is configured to supply air to an air conditioning system of an aircraft's cabin. The air supply means is further or alternatively configured to supply air to a flow control system of an aircraft. The control unit is configured to provide, during cruise conditions of the aircraft, a larger amount of the air to the air conditioning system than to the flow control system. The control unit is further configured to provide, during take-off and/or landing conditions of the aircraft, a larger amount of the air to the flow control system than to the air conditioning system.

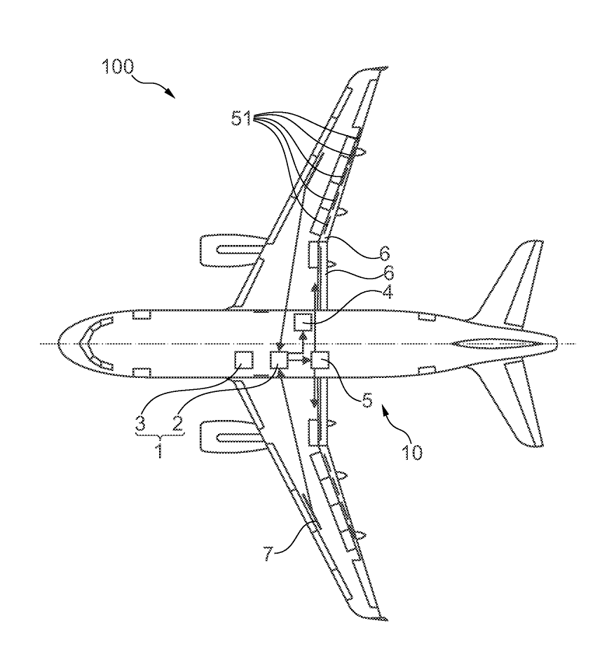

### FIELD OF THE INVENTION

The invention relates to an air generation unit for an aircraft, an air generation arrangement, an aircraft and a method for operating an air generation unit in an aircraft.

### BACKGROUND OF THE INVENTION

Multiple devices of an aircraft, as e.g. an air conditioning system or a flow control system need pressurized air which must be provided by some sort of air source. Conventionally, pressurized air is supplied by compressor units or extracted as bleed-air from turbofan engines. However, this supply of air can be improved. For example, compressors units have significant implications on aircraft weight, while a coupling to turbofan engines is unfavorable from a performance point of perspective.

### BRIEF SUMMARY OF THE INVENTION

Hence, there may be a need to provide an improved air generation unit for an aircraft, which allows reducing the aircraft's weight.

It should be noted that the aspects of the invention described in the following apply also to the air generation unit for an aircraft, the air generation arrangement, the aircraft and the method for operating the air generation unit in the aircraft.

According to an embodiment of the present invention, an air generation unit for an aircraft is presented. The air generation unit for an aircraft comprises an air supply means and a control unit. The air supply means is configured to supply air to an air conditioning system of an aircraft's cabin. The air supply means is further or alternatively configured to supply air to a flow control system of an aircraft. The control unit is configured to provide, during cruise conditions of the aircraft, a larger amount of the air to the air conditioning system than to the flow control system. The control unit is further configured to provide, during take-off and/or landing conditions of the aircraft, a larger amount of the air to the flow control system than to the air conditioning system.

Thereby, an embodiment of the present invention provides an integrated unit for cabin-air conditions/pressurization and flow control air supply. In other words, the air generation unit is used for cabin pressurization and air conditioning, as well as for flow control air supply. This double-use of infrastructure provides a weight benefit for the aircraft. Further, a decoupling from the compressor units and the turbofan engines is possible.

During take-off and landing, pressurization and air-conditioning is needed at a much lower extent than during cruise, sometimes even switched off, so that the air generation unit can be used for supplying pressurized air to the flow control. During cruise, however, flow control is needed at a much lower extent than during take-off and landing, sometimes switched off, so that the air generation unit can be used for supplying pressurized air to the air conditioning system. As a result, the air generation unit can be dimensioned according to cruise requirements.

The flow control system may be utilized, e.g., in order to prevent flows from separating or detaching from an airfoil portion or from another flow body, or to reattach a flow that has already detached or separated from the airfoil portion or other flow body. The flow control system may be also configured to provide boundary layer suction to inhale the detaching or detached boundary layer or to prevent laminar turbulent transition for better drag during cruise. Thereby, the flow control can lead to an increased lift by eliminating separations, while holding the angle of attack constant, or by delaying the stall of a particular surface to higher degrees of flow incidence, consequently increasing the lift as well.

The airfoil may be a flap, a wing, a winglet, a vertical or horizontal tail plane, a slat, a tap, a control surface, a mounting surface, a landing gear and/or a fuselage portion. In other words, the flow control system of the airfoil portion can be any part where separation of air flows occurs or where it is desired to suppress laminar turbulent transition and to reduce friction drag.

In an example, the control unit is configured to provide during cruise conditions between 80 and 100% of the air to the air conditioning system, preferably between 90 and 100%, and more preferably between 95 and 100%. In other words, the air generation unit may be dimensioned for cruise requirements of the air conditioning system.

In an example, the control unit is configured to provide during cruise conditions between 0 and 20% of the air to the flow control system, preferably between 0 and 10%, more preferably between 0 and 5%.

In an example, the control unit is configured to provide during take-off and/or landing conditions between 50 and 100% of the air to the flow control system, preferably between 60 and 80%, more preferably between 65 and 75%.

In an example, the control unit is configured to provide during take-off and/or landing conditions between 0 and 50% of the air to the air conditioning system, preferably between 20 and 40%, more preferably between 25 and 35%.

In an example, the air supply means are provided with air by an air intake at the airfoil. In other words, the air intake is used as suction device to inhale at least parts of the air that is used for cabin pressurization and acclimatization.

In an example, the air supplied to the air conditioning system and/or to the flow control system is pressurized air. The pressurized air may be pressurized in a range between 0 and 5 bar, preferably between 0 and 4 bar.

According to the present invention, also an air generation arrangement for an aircraft is presented. The air generation arrangement for an aircraft comprises an air generation unit as described above and a flow control system for the aircraft.

In an example, the flow control system is an active flow control system and comprises a fluidic actuator configured to provide a steady or unsteady air flow relative to a surface of the airfoil. The air flow relative to the surface of the airfoil portion may be along the surface, orthogonal, tangential or combinations thereof. The air flow may energize a detaching or detached boundary layer at the surface of the airfoil to modify the air circulation of the airfoil to e.g. introduce control moments or to reduce buffeting.

The at least one fluidic actuator maybe realized to provide a pulsed ejection from an opening in the airfoil. The fluidic actuator may utilize valves or other active flow influencing means for the provision of the pulsed flow. The air ejection is able to delay separations to higher flow incident angles by introducing vortical structures, which convect downstream of the airfoil thus energizing the otherwise separated flow area.

In summary, the active flow control system may comprise several openings and at least one fluidic actuator with an inlet connectable to an air source. The openings may be distributed along or parallel to e.g. a leading edge in a side-by-side relationship. The fluidic actuator may be designed such that air from the inlet flows to outlets connected to the openings.

According to an embodiment of the present invention, also an aircraft is presented. The aircraft comprises a cabin with an air conditioning system, an airfoil with a flow control system, and an air generation unit with an air supply means and a control unit as described above. The air supply means is configured to supply air to the air conditioning system and to a flow control system. The control unit is configured to provide, during cruise conditions of the aircraft, a larger amount of the air to the air conditioning system than to the flow control system, and during take-off and/or landing conditions of the aircraft, a larger amount of the air to the flow control system than to the air conditioning system.

In an example, at least parts of the flow control system are arranged at the airfoil. The airfoil may be a flap, an inboard flap, a wing, a winglet, a vertical or horizontal tail plane, a slat, a tap, a control surface, a mounting surface, and/or a fuselage portion.

In an example, the air generation unit is at least partially arranged close to the flow control system. The air generation unit may also be at least partially arranged at the airfoil and/or in a fuselage area next to the airfoil.

In an example, the air supply means are provided with air by an air intake at the airfoil. In other words, the air intake is used as suction device to inhale at least parts of the air that is used for cabin pressurization and acclimatization.

According to an aspect of the present invention, a method for operating an air generation unit in an aircraft is presented. It comprises a controlling of air supply to provide, during cruise conditions of the aircraft, a larger amount of the air to an air conditioning system of the aircraft than to a flow control system of the aircraft, and during take-off and/or landing conditions of the aircraft, a larger amount of the air to the flow control system than to the air conditioning system.

It shall be understood the air generation unit for an aircraft, the air generation arrangement, the aircraft and the method for operating an air generation unit in an aircraft according to the independent claims have similar and/or identical preferred embodiments, in particular, as defined in the dependent claims. It shall be understood further that a preferred embodiment of the invention can also be any combination of the dependent claims with the respective independent claim.

These and other aspects of the present invention will become apparent from and be elucidated with reference to the embodiments described hereinafter.

### BRIEF DESCRIPTION OF THE DRAWINGS

Exemplary embodiments of the invention will be described in the following with reference to the accompanying drawing:

FIGURE shows schematically and exemplarily an aircraft with an air generation arrangement comprising an air generation unit and a flow control system according to an embodiment of the invention.

### DETAILED DESCRIPTION

FIGURE shows schematically and exemplarily an aircraft 100 with an air generation arrangement 10 according to the invention. The air generation arrangement 10 comprises an air generation unit 1 and a flow control system 5.

The air generation unit 1 comprises an air supply means 2 and a control unit 3 arranged in a fuselage area next to the aircraft's wings. The air supply means 2 supplies air to an air conditioning system 4 of the aircraft's cabin and to the aircraft's flow control system 5. The control unit 3 provides, during cruise conditions of the aircraft 100, a larger amount of the air to the air conditioning system 4 than to the flow control system 5. The control unit 3 further provides, during take-off and/or landing conditions of the aircraft 100, a larger amount of the air to the flow control system 5 than to the air conditioning system 4.

In this embodiment, the control unit 3 provides during cruise conditions between 80 and 100% of the air to the air conditioning system 4 and between 0 and 20% of the air to the flow control system 5. During take-off and/or landing conditions, the control unit 3 provides between 50 and 100% of the air to the flow control system 5 and between 0 and 50% of the air to the air conditioning system 4.

The flow control system 5 is here an active flow control system arranged close to the air generation unit 1. The flow control system 5 comprises fluidic actuators 51 arranged at the aircraft's airfoil 6 to provide an air flow along a surface of the airfoil 6. The airfoil 6 is here a flap. The air flow may energize a detaching or detached boundary layer at the surface of the airfoil 6 to modify the air circulation of the airfoil 6 to e.g. introduce control moments or to reduce buffeting. The fluidic actuators 51 provide pulsed ejections from openings (not shown) in the airfoil 6. The openings are distributed along a leading edge of the flap in a side-by-side relationship. For e.g. an A320 type of aircraft, an air flow of 2 kg/s and 0.5 bar gauge pressure at the inboard flaps can be used.

The air supply means 2 are here provided with air by air intakes 7 arranged e.g. at outer portions of the aircraft's wings. In other words, the air intake 7 is used as suction device to inhale at least parts of the air that is used for cabin pressurization and acclimatization. The air supplied to the air conditioning system 4 and to the flow control system 5 is pressurized air, here in a range between 0 and 5 bar.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An air generation unit for an aircraft, comprising:
an air supply means; and
a control unit;
wherein the air supply means is configured to supply air to an air conditioning system of an aircraft's cabin and to a flow control system of the aircraft; and
wherein the control unit is configured to provide,
during cruise conditions of the aircraft, a larger amount of the air supplied by the air supply means to the air conditioning system than to the flow control system, and
during take-off and/or landing conditions of the aircraft, a larger amount of the air supplied by the air supply means to the flow control system than to the air conditioning system.

2. The air generation unit according to claim 1, wherein the control unit is configured to provide during cruise conditions between 80 and 100% of the air to the air conditioning system.

3. The air generation unit according to claim 1, wherein the control unit is configured to provide during cruise conditions between 90 and 100% of the air to the air conditioning system.

4. The air generation unit according to claim 1, wherein the control unit is configured to provide during cruise conditions between 95 and 100% of the air to the air conditioning system.

5. The air generation unit according to claim 1, wherein the control unit is configured to provide during take-off and/or landing conditions between 50 and 100% of the air to the flow control system, preferably between 60 and 80%, more preferably between 65 and 75%.

6. The air generation unit according to claim 1, wherein the control unit is configured to provide during take-off and/or landing conditions between 60 and 80% of the air to the flow control system.

7. The air generation unit according to claim 1, wherein the control unit is configured to provide during take-off and/or landing conditions between 50 and 100% of the air to the flow control system, preferably between 65 and 75%.

8. The air generation unit according to claim 1, wherein the control unit is configured to provide during take-off and/or landing conditions between 0 and 50% of the air to the air conditioning system.

9. The air generating unit according to claim 1, wherein the control unit is configured to provide during take-off and/or landing conditions between 20 and 40% of the air to the air conditioning system.

10. The air generating unit according to claim 1, wherein the control unit is configured to provide during take-off and/or landing conditions between 25 and 35% of the air to the air conditioning system

11. The air generation unit according to claim 1, wherein the air supplied to the air conditioning system and/or to the flow control system is pressurized air.

12. The air generation unit according to claim 11, wherein the pressurized air supplied to the air conditioning system is pressurized in a range between 0 and 5 bar.

13. The air generation unit according to claim 12, wherein the pressurized air supplied to the flow control system is pressurized in a range between 0 and 5 bar.

14. An aircraft comprising
a cabin with an air conditioning system,
an airfoil with a flow control system, and
an air generation unit comprising:
an air supply means; and
a control unit;
wherein the air supply means is configured to supply air to an air conditioning system of an aircraft's cabin and to a flow control system of the aircraft; and
wherein the control unit is configured to provide,
during cruise conditions of the aircraft, a larger amount of the air supplied by the air supply means to the air conditioning system than to the flow control system, and
during take-off and/or landing conditions of the aircraft, a larger amount of the air supplied by the air supply means to the flow control system than to the air conditioning system.

15. The aircraft according to claim 14, wherein the airfoil is a flap, a wing, a winglet, a vertical or horizontal tail plane, a slat, a tap, a control surface, a mounting surface, a landing gear and/or a fuselage portion.

16. The aircraft according to claim 14, wherein at least parts of the flow control system are arranged at the airfoil.

17. The aircraft according to claim 14, wherein the air generation unit is at least partially arranged close to the flow control system, preferably at the airfoil and/or in a fuselage area next to the airfoil.

18. The aircraft according to claim 14, wherein the air supply means are provided with air by an air intake at the airfoil.

19. The aircraft according to claim 14, wherein the flow control system comprises a fluidic actuator configured to provide an air flow relative to a surface of the airfoil.

20. A method for operating an air generation unit in an aircraft, comprising:
supplying of air; and
controlling of air to provide, during cruise conditions of the aircraft, a larger amount of the supplied air to an air conditioning system of the aircraft than to a flow control system of the aircraft, and
during take-off and/or landing conditions of the aircraft, a larger amount of the supplied air to the flow control system than to the air conditioning system.
